(19) United States
(12) Patent Application Publication
(10) Pub. No.: US 2013/0032430 A1
(43) Pub. Date: Feb. 7, 2013

(54) ELECTRICALLY-ASSISTED PARALLELOGRAM POWER STEERING SYSTEM

(71) Applicants: Miroslaw Zaloga, Shelby Township, MI (US); George E. Doerr, Clarkston, MI (US); Scott R. Kloess, Rochester Hills, MI (US); Christopher J. Mielke, Shelby Township, MI (US); Mauro Pacheco Escobedo, Troy, MI (US)

(72) Inventors: Miroslaw Zaloga, Shelby Township, MI (US); George E. Doerr, Clarkston, MI (US); Scott R. Kloess, Rochester Hills, MI (US); Christopher J. Mielke, Shelby Township, MI (US); Mauro Pacheco Escobedo, Troy, MI (US)

(73) Assignee: GM GLOBAL TECHNOLOGY OPERATIONS LLC, Detroit, MI (US)

(21) Appl. No.: 13/197,837

(22) Filed: Aug. 4, 2011

(51) Int. Cl. B62D 5/04

(52) U.S. Cl. 180/444

(57) ABSTRACT

A parallelogram steering system transfers torque to a relay rod in response to steering commands. The steering system includes an input member configured to receive the steering commands. A pitman arm and an idler arm are both movably connected to the relay rod. An idler shaft is operatively connected to the idler arm for common rotation therewith. The steering system also includes at least one electric motor, which is configured to selectively supply assist torque to the idler shaft in response to the steering commands.

### TECHNICAL FIELD

This disclosure relates to parallelogram or recirculating ball power steering systems for vehicles.

### BACKGROUND

Vehicles use steering systems to communicate commanded changes, such as through a steering wheel, in direction or course from the driver to the steerable wheels of the vehicle. Power steering systems assist the driver of the vehicle in steering by adding power to that supplied by the driver and, thereby, reducing the effort needed to turn the steering wheel manually.

### SUMMARY

A parallelogram steering system is provided. The steering system transfers torque to a relay rod in response to steering commands. The steering system includes an input member, which is configured to receive the steering commands. A pitman arm and an idler arm are both movably connected to the relay rod.

An idler shaft is operatively or fixedly connected to the idler arm for common rotation therewith. The steering system also includes at least a first electric motor, which is configured to selectively supply assist torque to the idler shaft in response to the steering commands. Therefore, the steering system can selectively supply assist torque to the relay rod in response to the steering commands.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic, isometric view of a parallelogram steering system having electrically-assisted idler and pitman mechanisms;

FIG. 2 is a more-detailed, partial cross-sectional view of the electrically-assisted pitman mechanism shown in FIG. 1, revealing portions of a transmission mechanism between an electric motor and a pitman arm;

FIG. 3A is a more-detailed view of the electrically-assisted idler mechanism shown in FIG. 1, having another electric motor and an idler arm;

FIG. 3B is a schematic, isometric, partial cross-sectional view of the electrically-assisted idler mechanism shown in FIG. 3A, revealing portions of a transmission mechanism between the electric motor and the idler arm;

FIG. 4 is a schematic, isometric, partial cross-sectional view of another electrically-assisted pitman mechanism usable with power steering systems, such as that shown in FIG. 1; and

FIG. 5 is a schematic, isometric view of another electrically-assisted idler mechanism usable with power steering systems, such as that shown in FIG. 1, showing a recirculating ball between a transmission mechanism and an idler arm.

### DETAILED DESCRIPTION

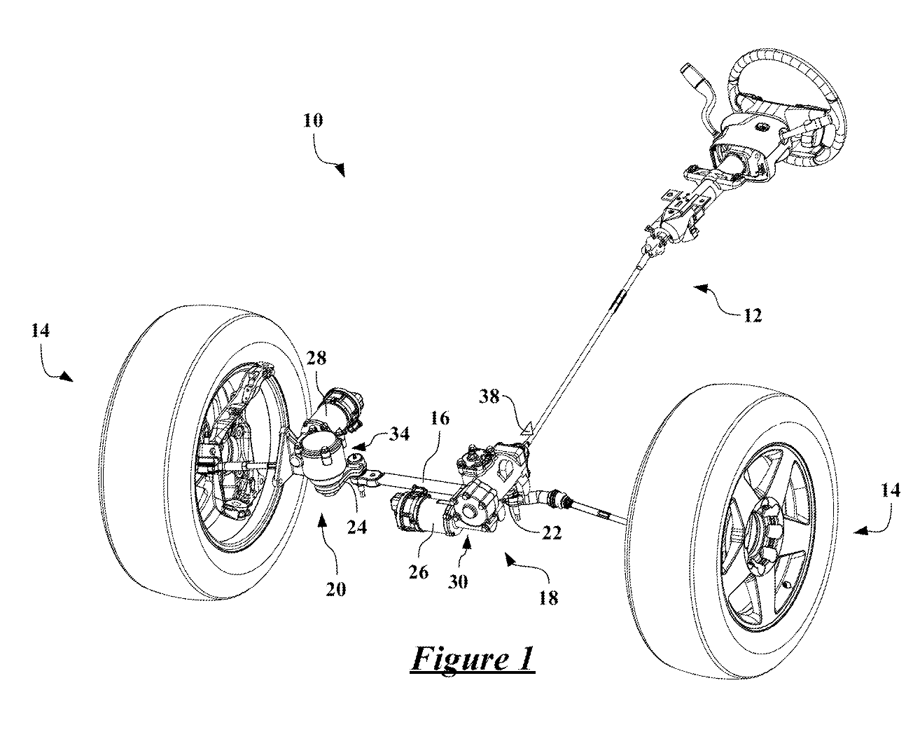

Referring to the drawings, wherein like reference numbers correspond to like or similar components whenever possible throughout the several figures, there is shown in FIG. 1 a schematic diagram of a parallelogram steering system 10 for a vehicle (the remainder of which is not shown). FIG. 1 shows some of the primary components of the steering system 10, which may be located toward the front of the vehicle. Features and components shown in other figures may be incorporated and used with those shown in FIG. 1, and components may be mixed and matched between the different configurations shown.

While the present invention is described in detail with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

The steering system 10 transfers rotation and torque from an input member, such as a steering wheel assembly 12, to an output member, such as one or more wheels 14. A steering column (not separately numbered) is attached to the steering wheel assembly 12, and includes various linkages, sensors, switches, and accessories. The wheels 14 of the vehicle are turned through movement of a relay rod 16 and attached components (not separately number, but including tie rods, steering knuckles, et cetera). The steering wheel assembly 12 shown is illustrative only and other types of steering devices may be used with the steering system 10.

The steering system 10 pivots the relay rod 16 with a pitman mechanism 18 and an idler mechanism 20. The pitman mechanism controls a pitman arm 22 and the idler mechanism 20 controls an idler arm 24. Together, the relay rod 16, pitman arm 22 and idler arm 24 generally form the corners (or pivot points) of a parallelogram, and the relay rod 16 moves generally parallel to the axis of rotation of the wheels 14. The pitman mechanism 18 and the idler mechanism 20 are rigidly attached to chassis or frame members (not shown).

The pitman mechanism 18, examples of which will be described in more detail herein, transfers torque from the steering wheel assembly 12 to the pitman arm 22 and may impart assist torque to the pitman arm 22. As described herein, the idler mechanism 20 may act as a neutral linkage or may impart assist torque to the idler arm 24 and the relay rod 16.

In the steering system 10 shown in FIG. 1, the steering wheel assembly 12 acts as the input member. Input signals—in the form of torque and rotational movement—are input to the steering wheel assembly 12 by the operator or driver of the vehicle. The front wheels 14 of the vehicle are the output members in the steering system 10 shown in FIG. 1.

Therefore, the pitman mechanism 18 and the idler mechanism 20 are intermediaries between the input from the steering wheel assembly 12 and the output to the relay rod 16 and the wheels 14. Other input and output members may be used with the steering system 10 and the pitman mechanism 18. For example, and without limitation, the pitman mechanism 18 and the idler mechanism 20 may receive input signals from a drive-by-wire or steer-by-wire system that does not mechanically link the steering wheel assembly 12 to the pitman mechanism 18. In drive-by-wire systems, the input member may be a solenoid or small electric machine and the steering column may be removed or shortened. Alternatively, the relay rod 16 may be linked to rear wheels (not shown) of the vehicle.

In order to selectively increase the torque transferred from the steering wheel assembly 12 to the relay rod 16, the steering system 10 may include one or more electric machines. In the configuration or setup shown in FIG. 1, the pitman mechanism 18 includes a first electric motor or pitman motor 26 and the idler mechanism 20 includes a second electric motor or idler motor 28. As used herein, designation of any component as “first” or “second” is arbitrary and non-limiting. Any component may be labeled as first, second, third, et cetera. The pitman mechanism 18 combines torque from the steering wheel assembly 12 and the pitman motor 26 to move the pitman arm 22 and the relay rod 16.

The steering system 10 may be characterized by the lack of a boost or assist mechanism on the steering column disposed between the steering wheel and the input to the pitman mechanism 18, such that the steering system 10 does not include column assist. Furthermore, the pitman mechanism 18 does not include a hydraulic boost or hydraulic assist. The amount of torque and power supplied by the pitman motor 26 and the idler motor 28 may be varied based upon driving conditions of the vehicle and the steering commands from the driver.

A first transmission mechanism or pitman drive unit 30 is disposed between the pitman motor 26 and a pitman shaft 32 (blocked from view in FIG. 1), which is fixedly connected to the pitman arm 22 for common rotation therewith. A second transmission mechanism or idler drive unit 34 is disposed between the idler motor 28 and an idler shaft 36 (blocked from view in FIG. 1), which is fixedly connected to the idler arm 24 for common rotation therewith.

One or more sensors 38, such as a torque sensor, a position sensor, or a force sensor, are arranged on the steering system 10. The sensor 38 shown in FIG. 1 is schematic and illustrative only, and any locations of sensors 38 within the steering system 10 are shown only to illustrate possible locations. The sensors 38 may be configured to measure a reaction torque, which is the torque reacting or pushing back against steering commands from the driver. The reaction torque may be viewed as a torque differential between the steering commands input from the steering wheel assembly 12 and the actual torque transferred to the wheels 14. For higher reaction torque, higher assist torque is needed from the pitman motor 26, the idler motor 28, or both, in order to turn the vehicle.

The steering system 10 may include a controller or control system (not shown). The control system may include one or more components with a storage medium and a suitable amount of programmable memory, which are capable of storing and executing one or more algorithms or methods to effect control of the steering system 10 and, possibly, other components of the vehicle. The control system is in communication with, at least, the pitman motor 26, the idler motor 28, and one or more of the sensors 38. The control system may be in communication with numerous other sensors and communication systems of the vehicle. Each component of the control system may include distributed controller architecture, such as a microprocessor-based electronic control unit (ECU). Additional modules or processors may be present within the control system.

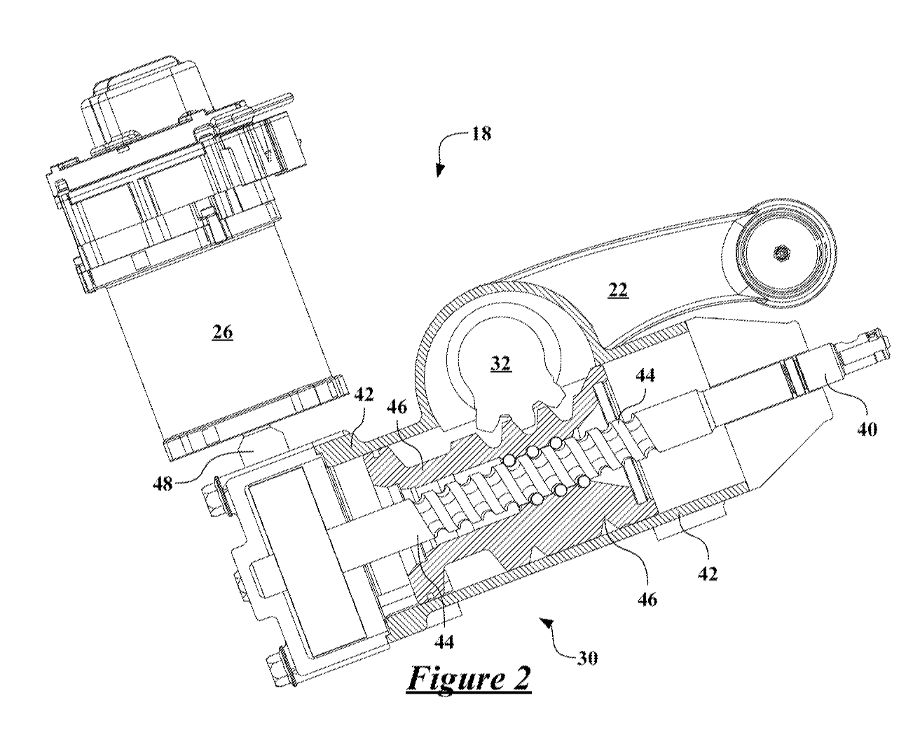

Referring now to FIG. 2, and with continued reference to FIG. 1, there is shown a more-detailed view of the pitman mechanism 18 shown in FIG. 1. FIG. 2 shows a top view of the pitman mechanism 18, which is partially cross-sectioned to illustrate features of the pitman drive unit 30. Features and components shown in other figures may be incorporated and used with those shown in FIG. 2, and components may be mixed and matched between the different configurations shown.

The pitman mechanism 18 combines torque transferred from the steering wheel assembly 12—or another input member—and torque from the pitman motor 26 and transfers torque to and from a pitman arm 22. An input shaft 40 is operatively connected to the steering wheel assembly 12, such as through the steering column and linkage and is carried within a housing 42. The input shaft 40 may be connected to other, alternative input members or may not be mechanically connected to the steering wheel assembly 12.

Portions of the housing 42 have either been removed or cross-sectioned to better illustrate the workings of the pitman mechanism 18. The housing 42 (and the other housing configurations shown in the other figures) is illustrative only and may take different forms from that shown in the figures. The housing 42 may be formed in more than one piece and include various seals and bearings to facilitate movement of the components of the pitman mechanism 18. The input shaft 40 has a ball screw 44 formed on one end. The ball screw 44 shown is formed as an integral, one-piece member with the input shaft 40.

A ball nut 46 circumscribes the ball screw 44 and is in torque-transfer communication with the ball screw 44 through a plurality of ball bearings, (shown schematically, not separately numbered), which circulate between the ball screw 44 and the ball nut 46. The housing 42 surrounds the ball nut 46 and guides movement thereof, such that the ball nut 46 slides but does not rotate within the housing 42. Rotation of the steering wheel assembly 12 causes the input shaft 40 and the ball screw 44 to rotate. As the ball screw 44 rotates, the rotation is transferred to the ball nut 46 and causes linear (left and right, as viewed in FIG. 2) movement of the ball nut 46.

The ball nut 46 is meshed with the pitman shaft 32 (which may also be referred to as a sector gear or sector shaft) for torque transfer. The pitman shaft 32 is rigidly attached, such as through a splined connection, to the pitman arm 22. The pitman shaft 32 and the pitman arm 22 rotate in common. Therefore, linear movement of the ball nut 46 causes rotation of the pitman shaft 32, such that movement of the steering wheel assembly 12 results in movement of the pitman shaft 32 and the pitman arm 22. The pitman shaft 32, ball screw 44, and ball nut 46 may be collectively referred to as a recirculating ball mechanism.

The sensors 38 monitor the torque and displacement of the input shaft 40 from the operator inputs to the steering wheel assembly 12, and also monitor the reactive torque transferred to the input shaft 40 by the vehicle wheels. The sensors 38 are shown only schematically and may include multiple sensors of different types. Furthermore, the sensors 38 may be in communication with one or more control systems (not shown) to process signals or commands from the sensors 38.

The pitman motor 26 is configured to selectively supply torque to the pitman shaft 32 through the pitman mechanism 18. This may be referred to as assist torque or boost torque. The amount of torque delivered by the pitman motor 26 may be variably delivered based upon, in part, the signals from the sensors 38, the control system, or other components and sensors. Furthermore, the pitman motor 26 may be controlled for use with other vehicle systems, including, but not limited to: electronic stability control, parking assist, and lane-departure. In rear-wheel steering or drive-by-wire configurations, the sensors 38 may directly monitor the steering wheel assembly 12, which may not be mechanically linked to the input shaft 40.

The pitman drive unit 30 is disposed between the pitman motor 26 and the ball nut 46, and enables torque transfer between the pitman motor 26 and the pitman shaft 32. The pitman drive unit 30 also provides mechanical advantage between the pitman motor 26 and the pitman shaft 32.

In addition to the recirculating ball mechanism, the pitman drive unit 30 includes a worm gear 48. The pitman drive unit 30 is directly connected to, and acts on, the ball screw 44 on the end of the housing 42 opposite from the input shaft 40—the forward side, relative to the forward direction of travel for the vehicle. The ball screw 44 then transfers torque to the ball nut 46. Therefore, the pitman motor 26 transfers assist torque through the worm gear 48 to the ball screw 44 and the ball nut 46, and then to the pitman shaft 32 and the pitman arm 22, which moves the relay rod 16.

Other configurations of the pitman drive unit 30, some of which are discussed herein, may be used with the pitman mechanism 18. For example, and without limitation, the pitman drive unit 30 may be driven by a chain or belt instead of the worm gear 48, or the pitman drive unit 30 may include other gears, sprockets, et cetera. Furthermore, the location of the connection from the pitman drive unit 30 may vary, as long as the linkage between the pitman motor 26 and the pitman shaft 32 is maintained for sufficient torque transfer and steering assistance.

Alternatively, the pitman mechanism 18 may be utilized with rear-wheel steering systems or drive-by-wire systems. In such a configuration, the pitman mechanism 18 may not include the input shaft 40 and the input signals would come from the control system, which may be monitoring the steering wheel assembly 12 and converting driver commands into torque needed to turn the wheels 14.

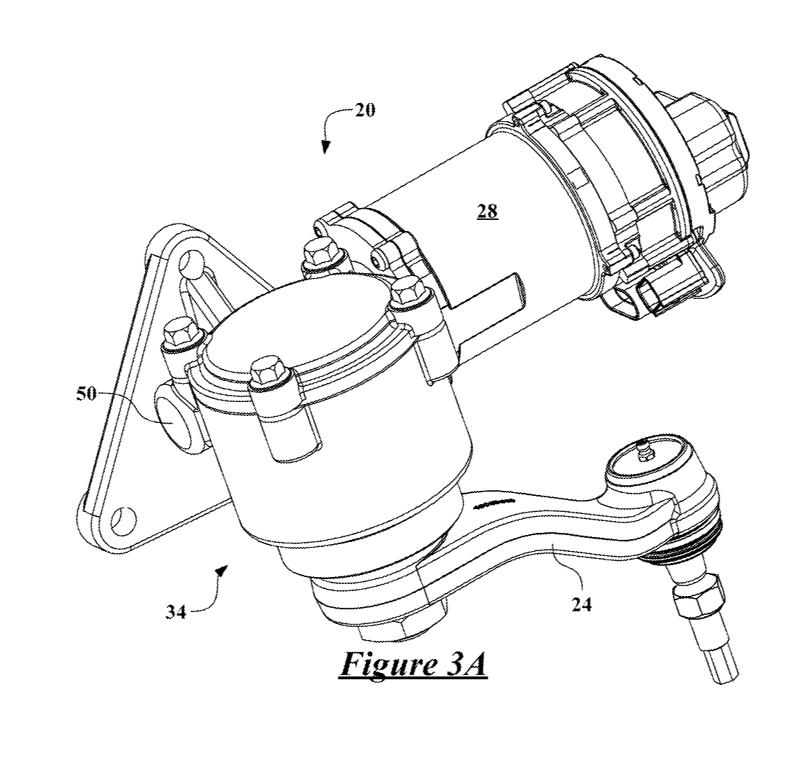

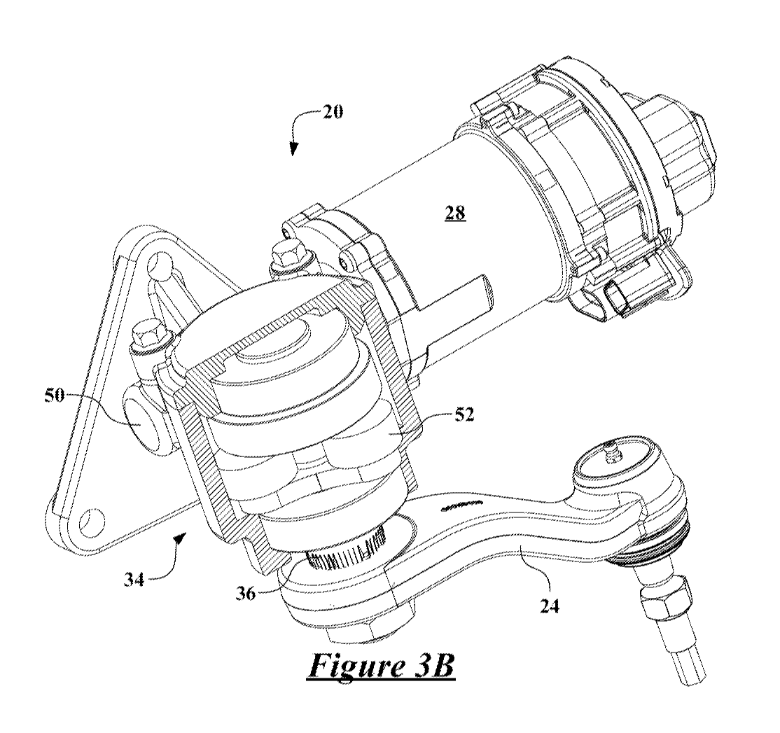

Referring now to FIG. 3A and to FIG. 3B, and with continued reference to FIGS. 1 and 2, there are shown more-detailed views of the electrically-assisted idler mechanism 20 shown in FIG. 1. FIG. 3B includes a partial cross-sectional view of the idler drive unit 34 shown in FIG. 3A, revealing portions of the gearing transmitting assist torque between the idler motor 28 and the idler arm 24 and also shows the idler shaft 36. Features and components shown in other figures may be incorporated and used with those shown in FIG. 3, and components may be mixed and matched between the different configurations shown.

The idler shaft 36 is operatively connected to the idler arm 24 for common rotation therewith, such as through a splined connection or another fixed connection. The idler motor 28 is configured to selectively supply assist torque to the idler shaft 36 through the idler drive unit 34 in response to the steering commands. The idler drive unit 34 provides mechanical advantage between the idler motor 28 and the idler shaft 36, which may allow the size of the idler motor 28 to be reduced. The idler arm 24 is movably connected to the relay rod 16.

In the configuration shown, the idler drive unit 34 includes a worm gear 50 and a planetary gear arrangement 52. The worm gear 50 is connected to the idler motor 28, which supplies a variable amount of assist torque through the planetary gear arrangement 52 to the idler shaft 36 based upon the reaction torque measured by the sensors 38.

Depending upon the amount of reaction torque, the steering system 10 may use the pitman motor 26, the idler motor 28, or both to provide assist torque. For example, and without limitation, the control system may be configured to compare the reaction torque to a calibrated transition value. When the reaction torque is below the calibrated transition value, the steering system 10 may use only one of the pitman motor 26 and the idler motor 28 to supply assist torque. However, when the reaction torque is above the calibrated transition value, the steering system 10 may the use both the pitman motor 26 and the idler motor 28 to supply assist torque.

Either of the pitman motor 26 or the idler motor 28 may be used as the primary motor when only one of the pitman motor 26 and the idler motor 28 is supplying assist torque to the steering system 10. For example, and without limitation, the pitman motor 26 may supply assist torque when the reaction torque is below the calibrated transition value (i.e., relatively low loads) and both the pitman motor 26 and the idler motor 28 may supply assist torque when the reaction torque is above the calibrated transition value (i.e., relatively high loads).

Furthermore, the control system may compare the reaction torque to a minimum boost value. When the reaction torque is below the minimum boost value, the steering system 10 may not use either the pitman motor 26 or the idler motor 28 to supply assist torque, such that the relay rod 16 is moved only by torque from the steering wheel assembly 12 (non-boosted or non-assisted steering).

The type of transmission mechanism, and also the mechanical advantage by the transmission, may be changed depending upon the configuration of the steering system 10, the pitman mechanism 18, and the idler mechanism 20. Larger, more-powerful, electric motors used for the pitman motor 26 and the idler motor 28 reduce the mechanical advantage needed from the pitman drive unit 30 and the idler drive unit 34, respectively.

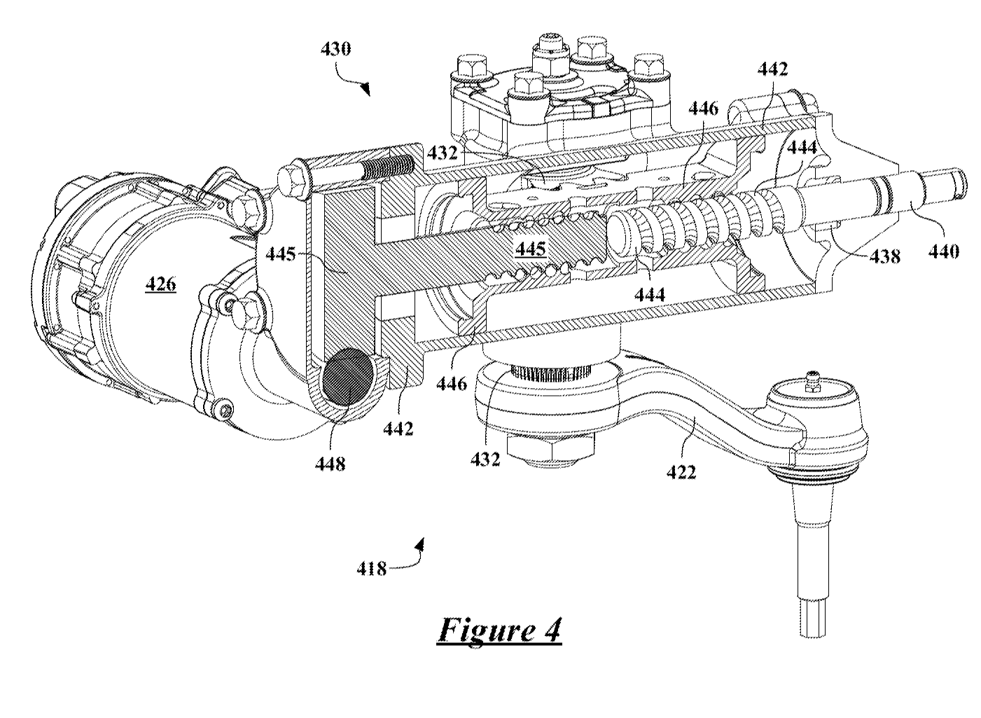

Referring now to FIG. 4, and with continued reference to FIGS. 1-3B, there is shown another pitman mechanism 418 usable with power steering systems, such as the steering system 10 shown in FIG. 1. FIG. 4 generally shows a side view of the pitman mechanism 418, with some of the components removed or cross-sectioned for illustrative purposes. Features and components shown in other figures may be incorporated and used with those shown in FIG. 4, and components may be mixed and matched between the different configurations shown.

The pitman mechanism 418 includes a pitman drive unit 430, which combines torque from a steering wheel (not shown) or another input member and a pitman motor 426 and transfers torque to and from a pitman arm 422. An input shaft 440 is operatively connected to the steering wheel and is carried within a housing 442. A cross-section plane has been taken through the housing 442 to better illustrate the workings of the pitman drive unit 430.

The input shaft 440 has a first ball screw 444 formed on one end. The first ball screw 444 shown is formed as an integral, one-piece member with the input shaft 440.

A first ball nut 446 circumscribes the first ball screw 444 and is in torque-transfer communication with the first ball screw 444 through a plurality of ball bearings (not shown), which circulate between the first ball screw 444 and the first ball nut 446. The housing 442 surrounds the first ball nut 446 and guides movement thereof. Rotation of the steering wheel causes the input shaft 440 and the first ball screw 444 to rotate. As the first ball screw 444 rotates, the rotation is transferred to the first ball nut 446 and causes linear movement (generally left and right, as viewed in FIG. 4) of the first ball nut 446.

The first ball nut 446 is meshed with a pitman shaft 432 (largely hidden from view) for torque transfer therewith. The pitman shaft 432 may be referred to as a sector gear or sector shaft and is rigidly attached, such as through a splined connection, to the pitman arm 422. Therefore, linear movement of the first ball nut 446 causes rotation of the pitman shaft 432, such that movement of the steering wheel results in movement of the pitman shaft 432 and the pitman arm 422.

The pitman mechanism 418 includes, or is in communication with, one or more sensors 438 configured to determine reaction torque and angular orientation at the input shaft 440 or the first ball screw 444. The sensors 438 monitor the torque and displacement of the input shaft 440 communicated from the operator inputs to the steering wheel, and also monitor the reactive torque transferred back to the input shaft 440 by the vehicle wheels (such as the wheels 14 shown in FIG. 1). The sensors 438 may include multiple sensors of different types and may be in communication with a control system (not shown) to process signals or commands from the sensors 438.

The pitman motor 426 is configured to selectively supply assist torque to the pitman shaft 432 through the pitman drive unit 430. The amount of assist torque delivered by the pitman motor 426 may be based, in part, upon the signals from the sensors 438, the control system, or other components and sensors.

The pitman drive unit 430 enables torque transfer between the pitman motor 426 and the pitman shaft 432. Portions of the pitman drive unit 430 have also been cross-sectioned to better illustrate the workings of the pitman drive unit 430.

The pitman drive unit 430 further includes a second ball screw 445, which is substantially coaxial with the first ball screw 444. The second ball screw 445 is also in torque-transfer communication with the first ball nut 446 through the plurality of ball bearings. Therefore, torque may be transferred to the first ball nut 446 from either or both of the first ball screw 444 and the second ball screw 445. Collectively, the first ball screw 444, second ball screw 445, and first ball nut 446 may be referred to as a recirculating ball mechanism.

In the configuration shown in FIG. 4, the pitman drive unit 430 is driven by the pitman motor 426 through a worm gear 448, which directly acts on the second ball screw 445. In the configuration shown in FIG. 4, the pitman motor 426 acts on the pitman drive unit 430 on the end of the housing 442 opposite from the input shaft 440. The connections between the pitman drive unit 430 and the pitman motor 426 are shown schematically.

The second ball screw 445 and the first ball screw 444 transfer input torque from the driver and assist torque from the pitman motor 426 to the first ball nut 446. Therefore, the pitman motor 426 selectively boosts the torque and power delivered to the pitman shaft 432 and the vehicle wheels (such as the wheels 14 shown in FIG. 1 or other wheels).

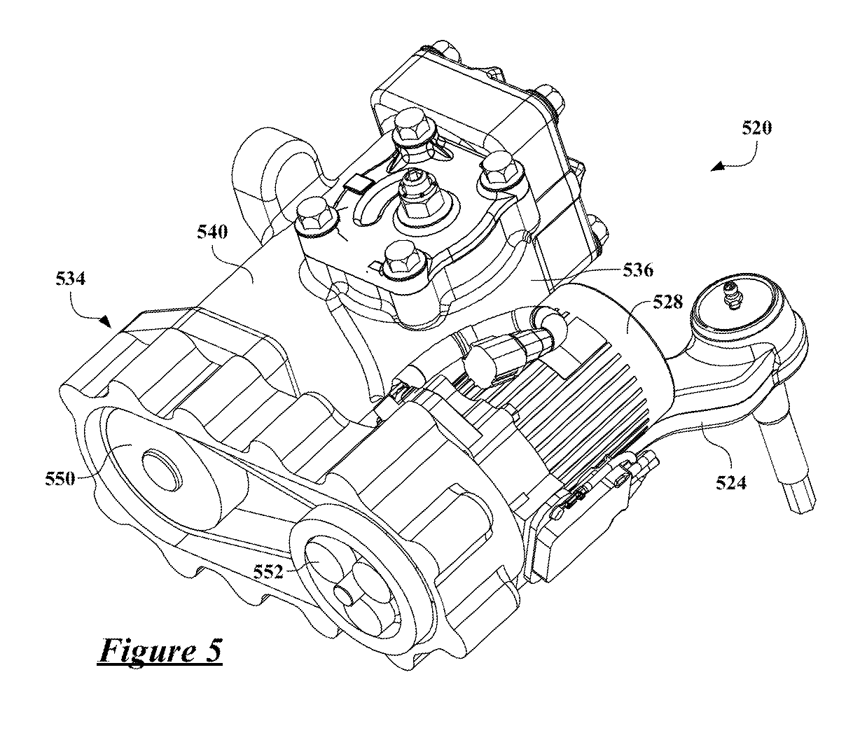

Referring now to FIG. 5, and with continued reference to FIGS. 1-4, there is shown another idler mechanism 520 usable with power steering systems, such as the steering system 10 shown in FIG. 1. FIG. 5 generally shows an isometric view of the idler mechanism 520, with some of the components removed or cross-sectioned for illustrative purposes. Features and components shown in other figures may be incorporated and used with those shown in FIG. 5, and components may be mixed and matched between the different configurations shown.

The idler mechanism 520 includes an idler arm 524, which receives assist torque from an idler motor 528 through an idler drive unit 534. The idler arm 524 is fixedly connected to an idler shaft, which is not shown but is within an idler housing 536, for common rotation. In the configuration shown, the idler drive unit 534 includes a recirculating ball mechanism 540, which may be similar to the recirculating ball mechanisms shown in FIGS. 2 and 4.

The idler motor 528 is configured to selectively supply assist torque to the idler shaft through the idler drive unit 534 in response to steering commands, such as from the steering wheel assembly 12 shown in FIG. 1 or another input member. The idler arm 524 may be movably connected to the relay rod 16 shown in FIG. 1.

In the configuration shown, the idler drive unit 534 includes a belt drive 550 and a planetary gear arrangement 552. The planetary gear arrangement 552 is connected to the idler motor 528, which supplies a variable amount of assist torque. The belt drive 550 connects the planetary gear arrangement 552 to the recirculating ball mechanism 540 and the idler shaft. Therefore, the idler drive unit 534 may provide more mechanical advantage between the idler motor 528 and the idler shaft than the idler drive unit 34 shown in FIGS. 3A and 3B. The type of transmission mechanism used, and also the mechanical advantage provided, may be changed depending upon the configuration of the steering system.

Depending upon the amount of reaction torque, the steering system 10 may use the pitman motor 26, the idler motor 28, or both to provide assist torque. For example, and without limitation, the control system may be configured to compare the reaction torque to a calibrated transition value. When the reaction torque is below the calibrated transition value, the steering system 10 uses only one of pitman motor 26 and the idler motor 28 to supply assist torque. However, when the reaction torque is above the calibrated transition value, the steering system 10 uses both the pitman motor 26 and the idler motor 28 to supply assist torque.

Furthermore, the control system may compare the reaction torque to a minimum boost value. When the reaction torque is below the minimum boost value, the steering system 10 may not use either the pitman motor 26 or the idler motor 28 to supply assist torque, such that the relay rod 16 is moved only by torque from the steering wheel assembly 12 (non-boosted or non-assisted steering).

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A parallelogram steering system for transferring torque to a relay rod in response to steering commands, comprising:
an input member configured to receive the steering commands;
a pitman arm movably connected to the relay rod;
an idler arm movably connected to the relay rod;
an idler shaft operatively connected to the idler arm for common rotation therewith; and
a first electric motor configured to selectively supply assist torque to the idler shaft in response to the steering commands.

2. The parallelogram steering system of claim 1, further comprising:
a torque sensor configured to measure a reaction torque opposing the steering commands, wherein the amount of assist torque supplied to the idler shaft by the first electric motor is based upon the reaction torque.

3. The parallelogram steering system of claim 2, further comprising
a first transmission mechanism disposed between the first electric motor and the idler shaft, wherein the first transmission mechanism provides mechanical advantage between the electric motor and the idler shaft.

4. The parallelogram steering system of claim 3, wherein the first transmission mechanism includes a first recirculating ball mechanism.

5. The parallelogram steering system of claim 4, further comprising:
a pitman shaft operatively connected to the pitman arm for common rotation therewith;
a second electric motor configured to selectively supply assist torque to the pitman shaft in response to the steering commands; and
a second transmission mechanism disposed between the second electric motor and the pitman shaft, wherein the second transmission mechanism provides mechanical advantage between the electric motor and the pitman shaft, and the amount of assist torque supplied to the pitman shaft by the second electric motor is based upon the reaction torque.

6. The parallelogram steering system of claim 5, wherein the second transmission mechanism includes a second recirculating ball mechanism transferring power between the second electric motor and the pitman shaft.

7. The parallelogram steering system of claim 6, further comprising:
a controller configured to compare the reaction torque to a calibrated transition value,
wherein one of the first electric motor and the second electric motor supplies assist torque when the reaction torque is below the calibrated transition value and both of the first electric motor and the second electric motor supply assist torque when the reaction torque is above the calibrated transition value.

8. A parallelogram steering system for transferring torque to a relay rod in response to steering commands, comprising:
an input member configured to receive the steering commands;
a pitman arm movably connected to the relay rod;
a pitman shaft operatively connected to the pitman arm for common rotation therewith;
an idler arm movably connected to the relay rod;
an idler shaft operatively connected to the idler arm for common rotation therewith;
a first electric motor configured to selectively supply assist torque to the idler shaft in response to the steering commands;
a first transmission mechanism disposed between the first electric motor and the idler shaft, wherein the first transmission mechanism provides mechanical advantage between the electric motor and the idler shaft;
a second electric motor configured to selectively supply assist torque to the pitman shaft in response to the steering commands; and
a second transmission mechanism disposed between the second electric motor and the pitman shaft, wherein the second transmission mechanism provides mechanical advantage between the electric motor and the pitman shaft, and the amount of assist torque supplied to the pitman shaft by the second electric motor is based upon the reaction torque.

9. The parallelogram steering system of claim 8, further comprising:
a torque sensor configured to measure a reaction torque opposing the steering commands, wherein the amount of assist torque supplied to the idler shaft by the first electric motor is based upon the reaction torque.

10. The parallelogram steering system of claim 9,
wherein the second transmission mechanism includes a recirculating ball mechanism transferring power between the second electric motor and the pitman shaft, and
wherein the first transmission mechanism is characterized by lack of a recirculating ball mechanism transferring power between the first electric motor and the idler shaft.

11. The parallelogram steering system of claim 10, further comprising:
a controller configured to compare the reaction torque to a calibrated transition value,
wherein one of the first electric motor and the second electric motor supplies assist torque when the reaction torque is below the calibrated transition value and both of the first electric motor and the second electric motor supply assist torque when the reaction torque is above the calibrated transition value.

12. A parallelogram steering system for transferring torque to a relay rod in response to steering commands, comprising:
an input member configured to receive the steering commands;
a pitman arm movably connected to the relay rod;
a pitman shaft operatively connected to the pitman arm for common rotation therewith;
an idler arm movably connected to the relay rod;
an idler shaft operatively connected to the idler arm for common rotation therewith;
a first electric motor configured to selectively supply assist torque to the idler shaft in response to the steering commands;
a first transmission mechanism disposed between the first electric motor and the idler shaft, wherein the first transmission mechanism provides mechanical advantage between the electric motor and the idler shaft;
a torque sensor configured to measure a reaction torque opposing the steering commands, wherein the amount of assist torque supplied to the idler shaft by the first electric motor is based upon the reaction torque;
a second electric motor configured to selectively supply assist torque to the pitman shaft in response to the steering commands; and
a second transmission mechanism disposed between the second electric motor and the pitman shaft, wherein the second transmission mechanism includes a recirculating ball mechanism transferring power between the second electric motor and the pitman shaft, the second transmission mechanism provides mechanical advantage between the electric motor and the pitman shaft, and the amount of assist torque supplied to the pitman shaft by the second electric motor is based upon the reaction torque.
